(19) United States
(12) Patent Application Publication
(10) Pub. No.: US 2005/0073542 A1
(43) Pub. Date: Apr. 7, 2005

(54) Inkjet printer

(75) Inventor: Tsutomu Yoneyama, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KONICA MINOLTA MEDICAL & GRAPHIC, INC., Tokyo (JP)

(21) Appl. No.: 10/950,769

(22) Filed: Sep. 27, 2004

(30) Foreign Application Priority Data
Oct. 2, 2003 (JP) JP2003-344307

(51) Int. Cl. B41J 2/205

(52) U.S. Cl. 347/15

(57) ABSTRACT

An inkjet printer for discharging an optimum number of light curable ink droplets for a single dot, wherein the recording head discharges “one” ink droplet in solid for a single dot as a first solid patch, “two” ink droplets as a second solid patch, and then “N” ink droplets as an “N” th solid patch, and next, the density of each solid patch is measured, thereafter the number of ink droplets existing in any one of the solid patches, is used as the optimum number of the ink droplets to be discharged for a single dot.

### BACKGROUND OF THE INVENTION

The present invention relates to an inkjet printer, particularly to an inkjet printer for adjusting the density when an image is recorded on various types of recording media.

In recent years, the inkjet printer has come to be employed in increasing numbers because of its simple and economical image formation method, as compared to other printers based on the method of using a printing press as in the gravure printing and flexographic printing.

One of the known inkjet printers is a photocurable inkjet printer wherein photocurable ink is discharged onto a recording medium and such light as an ultraviolet ray is applied to cure and fix the ink. Such an inkjet printer includes a recording head for forming a nozzle to discharge ink that is cured by application of light, and an ultraviolet irradiation apparatus equipped with a light source for issuing light to cure the ink. The ultraviolet irradiation apparatus applies light to the ink, discharged from the recording head, hitting the recording medium, whereby ink is cured to record the image.

When such an inkjet printer is used, an image can be recorded on the recording media composed of various types of sheets such as plain paper, recycled paper and glossy paper, fabrics, non-woven fabrics, resins, metals, glass and many other materials.

When the same number of the same ink droplets is discharged by a recording head, generally, when the recording medium such as plain paper characterized by excellent ink absorbency is used, ink penetrates the recording medium, resulting in a reduced density of the recorded image. When the recording medium of poor absorbency such as a metal is used, ink remains on the surface without penetrating the recording medium and tends to increase the density of the recorded image. Thus, if an image is to be recorded on various types of materials, some means must be taken for each recording medium to ensure that the recorded image will have a predetermined level of density.

One of the known inkjet printers wherein adjustment is made for each recording medium to ensure that the recorded image will have a predetermined level of density is the one wherein the distance between the recording head and light irradiation apparatus is changed to control the time, from when the ink discharged from the recording head has reached the recording medium, until light is applied to the ink by a light irradiation apparatus, whereby the degree of penetration of ink through the recording medium is adjusted (for example, Patent Document 1).

In the aforementioned inkjet printer, the information on the distance between the recording head and the light irradiation apparatus where appropriate density is obtained in conformity to the combination of ink and recording medium is stored in advance. When the combination between the ink and recording medium is selected, the distance between the recording head and light irradiation apparatus is changed and the image of a predetermined density is obtained.

[Patent Document 1] Official Gazette of Japanese Patent Tokkai 2003-159791

In the prior art inkjet printer (Patent Document 1), however, the time from when the ink discharged from the recording head has reached the recording medium, until light is applied to the ink by the light irradiation apparatus, is changed in conformity to the type of the recording medium. This has raised the problem of the productivity being reduced according to the type of the recording medium.

In the prior art photocurable inkjet printer, the image having the density conforming to the combination is obtained by selecting the combination between ink and recording medium, and an image can be recorded on the recording media composed of various types of materials. This prior art method, however, unduly restricts the range of selection by a user in some cases.

### SUMMARY OF THE INVENTION

In view of the prior art described above, it is an object of the present invention to provide an inkjet printer that provides a high-quality image of adequate density, independently of the type of a recording medium, without reducing the productivity.

The present invention of Structure 1 provides an ink-jet printer invented for solving the aforementioned problems includes:
a recording head for discharging the ink that is cured by light applied thereto, to a recording medium; and
a light irradiation apparatus for applying light to the ink having reached the recording medium so that the ink is cured. This inkjet printer is provided with a control section for controlling the aforementioned recording head. If N-ink droplets can be discharged for each dot through the recording head, the aforementioned control section controls the recording head so as to create a solid patch by discharging one- through N-ink droplets for each dot, in solids by a predetermined number of dots, that is, a series of the solid patches including a first to N th patches is created. It also controls the recording head so that the image is recorded, on condition that the number of ink droplets conforming to the density determined based on the aforementioned solid patch having been created is used as the maximum number, being the optimum number, of the ink droplets discharged for each dot.

According to the present invention described in Structure 1, the density suited for the recording medium on which an image is to be recorded is adjusted by changing the maximum number of the ink droplets discharged for each dot. This arrangement does not require modification of the time from when the ink discharged from the recording head has reached the recording medium, until light is applied to the ink by the light irradiation apparatus.

An appropriate density is determined based on the solid patch obtained by discharging ink onto the recording medium on which an image is to be recorded. This arrangement allows a user to select any desired recording medium.

The invention of Structure 2 provides an inkjet printer described in Structure 1, further including a density measuring device for measuring the density of the aforementioned solid patch, wherein, based on the result of measurement by the aforementioned density measuring device, the aforementioned control section sets the number of ink droplets immediately before the density reaches a saturation level, as the maximum number of ink droplets to be discharged for each dot.

In a recording medium with an image to be recorded thereon, the invention described in Structure 2 automatically sets the maximum number of ink droplets discharged for each dot to get an image having a density that provides a feeling of uniform gloss, free of irregularities due to accumulation of ink layers.

The invention described in Structure 3 provides an inkjet printer described in Structure 1, further including a density measuring device for measuring the density of the aforementioned solid patch, wherein, based on the result of measurement by the aforementioned density measuring device, the aforementioned control section sets the number of ink droplets corresponding to the density closest to the standard value, as the maximum number of ink droplets to be discharged for each dot.

According to the invention described in Structure 3, the arrangement of the invention automatically sets the maximum number of ink droplets to be discharged for each dot that provides an image having a standard density of a certain level.

The invention described in Structure 4 provides an inkjet printer described in Structure 2 or 3, further including recording heads each discharging its own color, wherein the control section sets the aforementioned maximum number of the ink droplets for each color.

According to the invention described in Structure 4, the arrangement of the invention automatically sets the maximum number of ink droplets to be discharged for each dot that provides an image having an appropriate density for each color of ink.

The invention described in Structure 5 provides an inkjet printer described in Structure 1, further including an input section for inputting a user's instruction, wherein the aforementioned control section controls the recording head in such a way that the image will be recorded, on condition that the number of ink droplets inputted from the input section is set as the maximum number of ink droplets to be discharged for each dot.

According to the invention described in Structure 5, in a recording medium with an image to be recorded thereon, the arrangement of the invention can set the maximum number of ink droplets to be discharged for each dot, wherein the image carrying the density selected by the user, is obtained.

The invention described in Structure 6 provides an inkjet printer described in Structure 4, further including recording heads each discharging its own color, wherein the maximum number of ink droplets can be inputted for each color.

According to the invention described in Structure 6, the arrangement of the invention can set the maximum number of ink droplets to be discharged for each dot that provides an image having an appropriate density for each color of ink.

### EFFECTS OF THE INVENTION

According to the present invention described in Structure 1, the density suited for the recording medium on which an image is to be recorded is adjusted by changing the maximum number of the ink droplets discharged for each dot. This arrangement prevents the productivity from being reduced depending on the type of a recording medium.

The density is determined based on the solid patch obtained by discharging ink onto the recording medium on which an image is to be recorded. This arrangement allows a user to select any desired recording medium and to get a high-quality image of appropriate density.

In a recording medium selected freely by the user, the invention described in Structure 2 produces an image having a density that provides a feeling of uniform gloss, free of irregularities due to accumulation of ink layers.

In a recording medium selected freely by the user, the invention described in Structure 3 provides a high quality image having a standard density of a certain level, without reducing the level of productivity.

In a recording medium selected freely by the user, the invention described in Structure 4 produces a high quality image recorded at an appropriate density set for each ink color, without reducing the level of productivity.

In a recording medium selected freely by the user, the invention described in Structure 5 produces a high quality image of the density selected by the user, without reducing the level of productivity.

In a recording medium selected freely by the user, the invention described in Structure 6 produces a high quality image recorded at an appropriate density set by the user for each ink color, without reducing the level of productivity.

### BRIEF DESCRIPTION OF THE DRAWINGS

FIG. 1 is a drawing representing the configuration of an embodiment of an inkjet printer of the present invention;

FIG. 2 is a block diagram representing the configuration of the present embodiment;

FIG. 3 is a drawing representing an example of the solid patch created by the inkjet printer of the present embodiment; and

FIG. 4(A) is a graphic representation of the result of measuring the density of the solid patch formed on synthetic paper by discharging five ink droplets for each dot; FIG. 4(B) is a graphic representation of the result of measuring the density of the solid patch formed on a PVC sheet (polyvinyl chloride sheet) by discharging five ink droplets for each dot.

### DETAILED DESCRIPTION OF THE PREFERRED EMBODIMENT

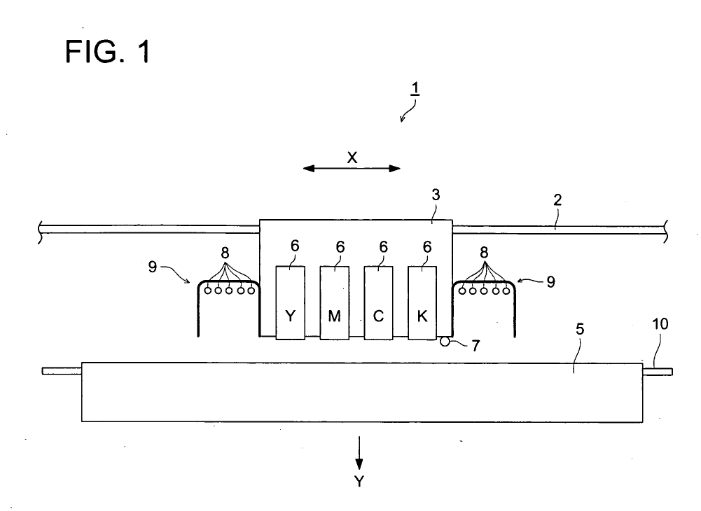

Referring to FIGS. 1 through 4, the following describes the preferred embodiment of the present invention:

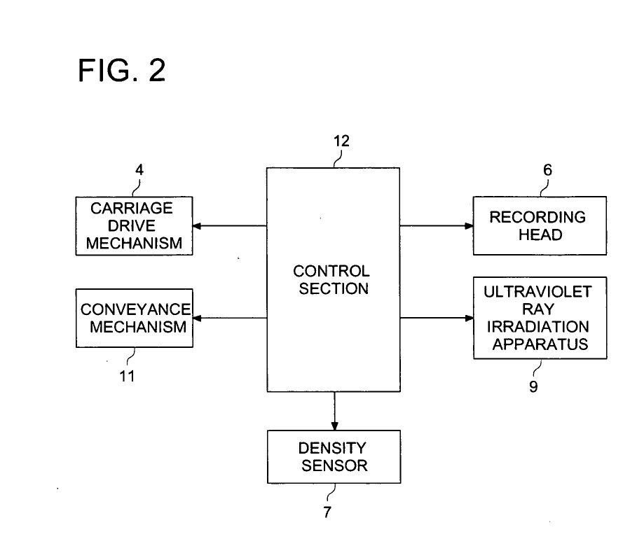

FIG. 1 shows a serial head type inkjet printer 1 as an embodiment of the inkjet printer of the present invention. As shown in FIG. 1, the inkjet printer 1 has a rod-shaped guide rail 2, which supports a carriage 3. The carriage 3 is driven to make a reciprocating motion by a carriage drive mechanism 4 (see FIG. 2) along the guide rail 2 in the main scanning direction X.

The carriage 3 is provided with a recording head 6 having a nozzle (not illustrated) for discharging the ink of each of the colors, yellow (Y), magenta (M), cyan (C) and black (K), onto the recording medium 5.

The ink used in the present embodiment is an ultraviolet cure ink that is cured when exposed to ultraviolet ray. The ultraviolet cure ink as a polymerizable compound that can be used includes:
radical polymerizable ink containing a radical polymerizable compound;
cationic polymerizable ink containing the cationic polymerizable compound; and
hybrid ink composed of the radical polymerizable ink and cationic polymerizable ink. It is particularly recommended to use the cationic polymerizable ink characterized by superb functionality and versatility, without practically any inhibiting action of polymerization due to oxygen. Ink can be used with a polymerizable compound that is polymerized and cured by the light other than ultraviolet ray, and a photo-initiator that initiates the polymerization reaction of polymerizable compounds using such light as an electron beam, X-ray and infrared ray other than ultraviolet ray.

The recording medium 5 that can be used includes recording media composed of various types of sheets such as plain paper, recycled paper and glossy paper, fabrics, non-woven fabrics, resins, metals, glass and many other materials.

A density sensor 7, composed of a photo-sensor and CCD (charge coupled device), for measuring the density of the image recorded on the recording medium 5 located below the carriage 3 is mounted on one side opposite to the recording medium 5 of the carriage 3.

An ultraviolet ray irradiation apparatus 9, equipped with a light source 8, as a light irradiation apparatus for applying ultraviolet ray to the ink discharged from the nozzle to the recording medium 5 is arranged on each side of the carriage 3. A mercury lamp, metal halide lamp, excimer lamp, ultraviolet laser or LED (Light-Emitting Diode) can be used as a light source 8.

The central portion of the area where the carriage 3 can travel is assumed as a recording area for recording an image on the recording medium 5. This recording area incorporates a platen 10 for supporting the recording medium 5 horizontally from a non-recording area.

The inkjet printer 1 contains a conveyance mechanism 11 (see FIG. 2) for conveying the recording medium 5 in the sub-scanning direction Y orthogonal to the main scanning direction X. When the image is recorded, the conveyance mechanism 11 repeats the conveyance and suspension of the recording medium 5 in conformity to the operation of the carriage 3, and conveys the recording medium 5 intermittently.

FIG. 2 shows the control apparatus for controlling the inkjet printer 1 of the present embodiment. This control apparatus is composed of a CPU, RAM and ROM (not illustrated), for example, and contains the control section 12 wherein the processing program recorded on the ROM is expanded on the RAM and the processing program is executed by the CPU.

According to the aforementioned processing program, the control section 12 controls the operation of each member, based on the status of the carriage drive mechanism 4, conveyance mechanism 11, recording head 6 and ultraviolet ray irradiation apparatus 9.

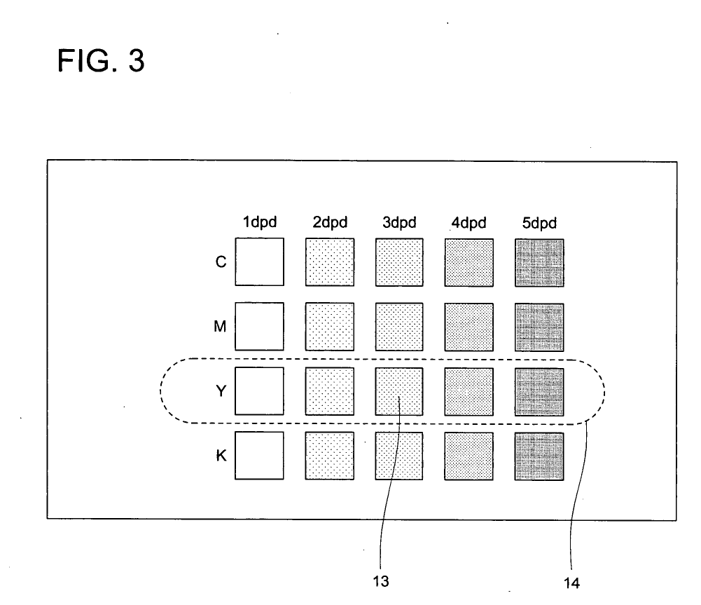

Especially in the inkjet printer 1, when N-ink droplets can be discharged for each dot by the recording head 6 of each color, the control section 12 controls the control section 12 so as to create solid patch 13 (see FIG. 3) by discharging one- through N-ink droplets for each dot, in solids by a predetermined number of dots. Numeral 14 is a series of the solid patches. For example, when five ink droplets for each dot can be discharged for each solid patch, 1 to 5 ink droplets for each dot are discharged for each solid patch, thereby creating the solid patch 13 wherein a square image of each color having a predetermined size is recorded, as shown in FIG. 3.

Further, in the inkjet printer 1, the control section 12 is connected with the density sensor 7. The control section 12 operates the carriage drive mechanism 4 to cause a reciprocating motion of the carriage, and operates the density sensor 7 to measure the density of the solid patch 13. Based on the result of measurement by the density sensor 7, the control section 12 determines the number of the ink droplets conforming to the appropriate density, for each color, and the determined number of the ink droplets for each ink is set as the maximum number of the ink droplets to be discharged for each dot by the recording head 6 for discharging each color.

To put it more specifically, when the rate of density increase resulting from increase in the number of ink droplets is reduced below a predetermined level, and a slowdown is observed in the rate of density increase, the control section 12 assumes that the density has reached the level of saturation. The number of the ink droplets immediately before the density reaches the level of saturation is determined as the number of the ink droplets conforming to the appropriate density, the determined number of ink droplets is set as the maximum number of the ink droplets to be discharged for each dot.

The ROM stores the standard value of appropriate density in advance. When the rate of density increase resulting from the increase in the number of ink droplets is not reduced below a predetermined level, the control section 12 provides control in such a way that the number of ink droplets conforming to the density closest to the standard value is set as the maximum number of the ink droplets to be discharged for each dot.

The following describes the operation of the present embodiment:

When an image is to be recorded on the recording medium 5 selected as desired, the recording head 6 is controlled by the control section 12, and one- through N-ink droplets for each dot are discharged in solids by a predetermined number of dots, to the recording medium 5 where an image is to be recorded, whereby the solid patch 13 is created.

Then the density sensor 7 is operated by the control section 12 and the carriage drive mechanism 4 is also operated, whereby the density sensor 7 arranged on the carriage scans the upper portion of the solid patch 13 to measure the density of the solid patch 13.

The control section 12 determines the number of ink droplets conforming to the appropriate density based on the result of measuring by the density sensor 7. The determined number of ink droplets is set as the maximum number of ink droplets to be discharged for each dot by the recording head 6.

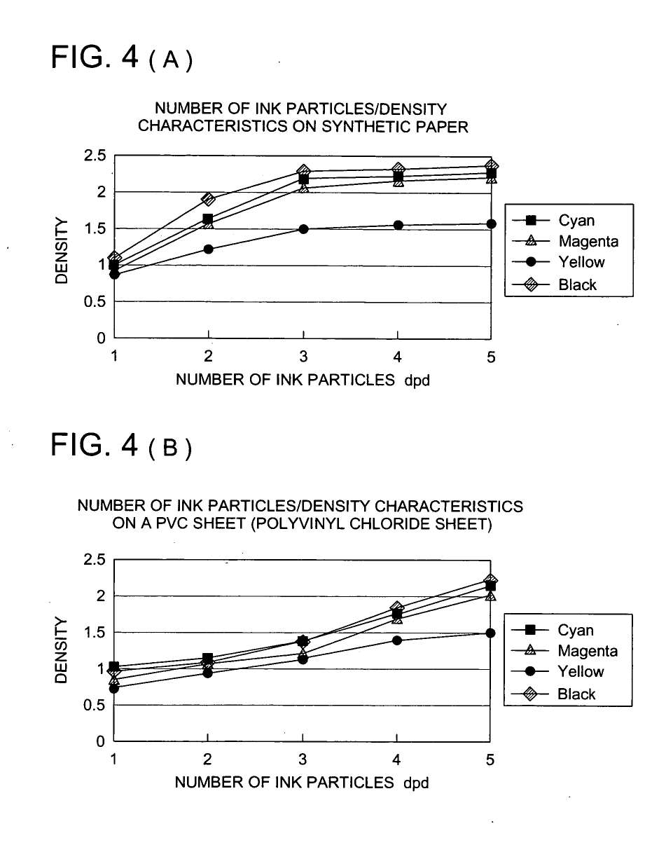

Referring to specific examples, the following describes the setting of the maximum number of ink droplets to be discharged for each dot by the recording head 6: For the synthetic paper, FIG. 4(A) graphically represents the result of measuring the density of the solid patch 13 formed on synthetic paper by discharging five ink droplets for each dot. FIG. 4(B) graphically represents the result of measuring the density of the solid patch 13 formed on a PVC sheet (polyvinyl chloride sheet) by discharging five ink droplets for each dot.

In FIG. 4(A), a slowdown is observed in the rate of density increase resulting from increase in the number of ink droplets. When the number of the ink droplets is 3 or more, the density is assumed as having reached the level of saturation, for each color. Two ink droplets immediately before the density has reached the level of saturation are determined as the number of the ink droplets conforming to the appropriate density. The determined two ink droplets are set as the number of the ink droplets to be discharged for each dot. In the recording medium 5 where an image is to be recorded, this arrangement automatically sets the maximum number of ink droplets discharged for each dot to get an image having a density that provides a feeling of uniform gloss, free of irregularities due to accumulation of ink layers.

In FIG. 4(B), a slowdown in the rate of density increase resulting from increase in the number of ink droplets is not observed. Thus, the number of ink droplets conforming to the density closest to the standard value is set as the maximum number of ink droplets discharged for each dot. In this case, assume that 1.6 is stored in the ROM in advance as a standard value for yellow (Y), magenta (M), cyan (C) and black (K), and 1.9 for black (K), for example. The five ink droplets for the yellow (Y) and four ink droplets for the magenta (M) and cyan (C) are set as the maximum number of ink droplets. For the recording medium 5 where an image is to be recorded, this arrangement automatically sets the maximum number of ink droplets to be discharged for each dot capable of providing an image of a certain standard density.

When an image is recorded on the recording medium 5, the drive mechanism of the carriage 3 is actuated by the control section 12 and the carriage 3 makes a reciprocating motion over the recording medium 55 in the main scanning direction X. Based on a predetermined image information, ink of a predetermined color is discharged from the recording head 64. In this case, the number of ink droplets of each dot is changed, using the preset number of ink droplets as the maximum number of ink droplets to be discharged for each dot, whereby gradation can be represented.

The ink droplets having been discharged hit the recording medium 55, and the ultraviolet ray is sequentially applied to the ink droplets hitting this recording medium 55 by the ultraviolet ray irradiation apparatus 96 making a reciprocating motion together with the carriage 3. Then the ink is cured on the recording medium 55. The conveyance mechanism 11 is controlled by the control section 12 in such a way that the recording medium 5 is conveyed in the sub-scanning direction Y, and the image is recorded on the recording medium 5.

According to the present embodiment, the density suited for the recording medium 5 on which an image is to be recorded is adjusted by changing the maximum number of the ink droplets discharged for each dot. This arrangement prevents the productivity from being reduced depending on the type of a recording medium.

Density is determined based on the solid patch 13 obtained by discharging ink onto the recording medium 5 on which an image is to be recorded. This arrangement allows a high quality image of appropriate density to be formed on a recording medium selected by a user.

In the present embodiment, the control section 12 determines the number of the ink droplets conforming to the appropriate density, based on the result of measuring the density by the solid patch 13, and the determined number of the ink droplets for each ink is set as the maximum number of the ink droplets to be discharged for each dot. It is also possible to arrange such a configuration that an input section, consisting of a touch panel or the like, for inputting a user's instruction is provided on the top of the casing of the inkjet printer 1, and the number of ink droplets conforming to the density selected by the user based on the solid patch 13 is inputted through the input section, wherein the control section 12 controls the recording head 6 so that an image can be recorded on condition that the inputted number of ink droplets is used as the maximum number of ink droplets to be discharged for each dot.

In this case, it is also possible to make such arrangements that the density is measured by an external density measuring device without installing a density measuring device on the inkjet printer 1. It is also possible to arrange such a configuration that the user determines the number of ink droplets conforming to the appropriate density, based on the solid patch 13, without measuring the density measuring device.

1. An inkjet printer for discharging an optimum number of light curable ink droplets for a single dot, comprising:
a recording head for discharging a light curable ink droplet onto a recording medium;
a light irradiation device for applying light to the light curable ink droplet having reached the recording medium so that the light curable ink droplet is cured;
a control section for controlling the recording head to create a series of solid patches including “N” solid patches on the recording medium, and
a density measuring device for measuring a density of a series of the solid patches,
wherein the recording head discharges “one” ink droplet in solid for a single dot as a first solid patch, “two” ink droplets for a single dot as a second solid patch, and then “N” ink droplets for a single dot as an “N” th solid patch, so that a series of the solid patches including “N” solid patches is created, and next, the density of each solid patch is measured by the density measuring device, thereafter the number of ink droplets existing in any one of the solid patches of a series of the solid patches, is used as the optimum number of the ink droplets to be discharged for a single dot.

2. The inkjet printer described in claim 1, wherein, based on the result of measurement by the density measuring device, the control section sets the number of ink droplets immediately before the density of a series of solid patches reaches a saturation level, as the optimum number of ink droplets to be discharged for a single dot.

3. The inkjet printer described in claim 1, wherein, based on the result of measurement by the density measuring device, the control section sets the number of ink droplets based on the density of a series of solid patches closest to a standard density value, as the optimum number of ink droplets to be discharged for a single dot.

4. The inkjet printer described in claim 2, wherein the recording heads includes the recording heads for discharging each color, and the control section sets the optimum number of ink droplets for each color.

5. The inkjet printer described in claim 1, further comprising an input section for inputting a user's instruction, wherein the control section controls the recording head in such a way that the image will be recorded, on condition that the number of ink droplets inputted via the input section is set as the optimum number of ink droplets to be discharged for a single dot.

6. The inkjet printer described in claim 4, wherein the optimum number of ink droplets is inputted for each color.

7. The inkjet printer described in claim 1, wherein the optimum number of ink droplets is a maximum number of ink droplets in a series of the solid patches.
